(19) United States
(12) Patent Application Publication
(10) Pub. No.: US 2003/0002950 A1
(43) Pub. Date: Jan. 2, 2003

(54) Torque shearing nut system and method

(76) Inventor: Matthew Harvey Jameson, Coleman, TX (US)

Correspondence Address: KEVIN MARK KLUGHART, 2516 LILLIAN MILLER PARKWAY, SUITE 115, DENTON, TX, 76210-7205, US

(21) Appl. No.: 10/175,312

(22) Filed: Jun. 19, 2002

Related U.S. Application Data
(60) Provisional application No. 60/302,139, filed on Jun. 30, 2001.
(60) Provisional application No. 60/315,127, filed on Aug. 27, 2001.
(60) Provisional application No. 60/332,189, filed on Nov. 13, 2001.

(51) Int. Cl. F16B 31/00

(52) U.S. Cl. 411/3

(57) ABSTRACT

A torque shearing nut system and method incorporating a hybrid “twistnut” constructed of a metallic force bearing member and a thermoplastic rubber (Vyram®, etc.) and/or plastic (polyamide (nylon), polypropylene (PP), etc.) surrounding support member is disclosed. The present invention permits the use of one or more steel washer inserts formed to permit shearing of an external axial element for the purposes of ensuring the application of a predefined torque to the external axial member. The primary advantage of the present invention is one of cost, in that the present invention can be manufactured using stamped steel washers that are surrounded with and impregnated with molded thermoplastic rubber (Vyram®, etc.) and/or plastic (polyamide (nylon), polypropylene (PP), etc.). This encapsulation process is significantly less expensive than traditional hot-forging methodologies used to manufacture prior art twistnuts and the like. Furthermore, the present invention permits a reduction in the complexity of steps required to both manufacture the twistnuts as well as combine them with the external axial member. The present invention may be manufactured without the need for specialized hot forge tooling and hot forge machinery, and as such the production volume limitations of the prior art are not present in the manufacture of the present invention.

### CROSS REFERENCE TO RELATED APPLICATIONS

### Provisional Patent Applications

Applicant claims benefit pursuant to 35 U.S.C. §119 and hereby incorporates by reference Provisional Patent Application for “TORQUE SHEARING NUT SYSTEM AND METHOD”, S/No. 60/302,139, docket MHJ-2001-001, filed Jun. 30, 2001, and submitted to the USPTO with Express Mail Label EF409812974US.

Applicant claims benefit pursuant to 35 U.S.C. §119 and hereby incorporates by reference Provisional Patent Application for “TORQUE SHEARING NUT SYSTEM AND METHOD”, S/No. 60/315,127, docket MHJ-2001-002, filed Aug. 27, 2001, and submitted to the USPTO with Express Mail Label EF409812435US.

Applicant claims benefit pursuant to 35 U.S.C. §119 and hereby incorporates by reference Provisional Patent Application for “TORQUE SHEARING NUT SYSTEM AND METHOD”, S/No. 60/332,189, docket MHJ-2001-003, filed Nov. 13, 2001, and submitted to the USPTO with Express Mail Label ET702669137US.

### Utility Patents

Applicant hereby incorporates by reference U.S. Pat. No. 4,092,036 for PIPE JUNCTION HOLDER issued May 30, 1978 to Toshiyuki Sato and Hideo Edo, and initially assigned to Kabushiki Kaisha Suiken of Osaka, Japan.

Applicant hereby incorporates by reference U.S. Pat. No. 4,568,112 for PIPE JOINT RESTRAINER GLANDS issued Feb. 4, 1986 to Earl C. Bradley, Jr., Jack Burkholder, Earl F. Bullock and assigned to EBBA [sic] Iron Inc. of Eastland, Tex., USA.

Applicant hereby incorporates by reference U.S. Pat. No. 4,627,774 for LIMITING TORQUE BOLT-NUT ASSEMBLY issued Dec. 9, 1986 to Earl T. Bradley, and assigned to EBAA Iron Inc. of Eastland, Tex., USA.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

As illustrated in FIG. 1 (0100), the present invention is related directly to construction techniques that incorporate “twistnuts” (twist-off bolts and/or nuts) (0101) which are specifically constructed to permit mechanical assembly of various materials with a known certainty given specific fasteners and a known fastening torque. These systems generally incorporate a twistnut assembly (0101) that is twisted off of another rod-member (0102) via the use of some torque-application device (0103).

Generally, the present invention deals specifically with improvements in the twist-off nut that may be used to properly torque an axial element (screw, threaded rod, etc.) (0102). The fabrication of these twist-off nuts generally requires the use of a Hatebur (or equivalent) hot forging press, an expensive and time consuming process that has both cost and throughput drawbacks in high-volume production environments.

While the present invention is particularly amenable to applications in which twistnuts and the like are to be directly replaced by a more cost-effective solution, the present invention also provides some benefits over the prior art that extend beyond mere cost and volume production issues.

While the present invention has a wide scope of applicability, it is particularly amenable to situations as illustrated in FIG. 1 (0100) in which a twist-off nut (0101) is used to cinch or tighten a retaining gland (0104) used to mate various types of pipe (cast iron, PVC, etc.) via the use of a retaining member (0105). Such exemplary applications are detailed generally in U.S. Pat. No. 4,092,036 for PIPE JUNCTION HOLDER issued May 30, 1978 to Toshiyuki Sato and Hideo Edo, and initially assigned to Kabushiki Kaisha Suiken of Osaka, Japan and U.S. Pat. No. 4,568,112 for PIPE JOINT RESTRAINER GLANDS issued Feb. 4, 1986 to Earl C. Bradley, Jr., Jack Burkholder, Earl F. Bullock and assigned to EBBA [sic] Iron Inc. of Eastland, Tex., USA. Specifically, the present invention provides an improved methodology of implementing torque bolt-nut assemblies as generally illustrated in U.S. Pat. No. 4,627,774 for LIMITING TORQUE BOLT-NUT ASSEMBLY issued Dec. 9, 1986 to Earl T. Bradley, and assigned to EBAA Iron Inc. of Eastland, Tex., USA.

### BACKGROUND OF THE INVENTION

### Bolting Methods

There are four and only four methods allowed to measure whether structural bolts are correctly installed. They include the following:

Calibrated Wrench

This method is sometimes known erroneously as “torque control”. The Research Council stipulates that each day, for each different diameter, length, and grade of bolts, a representative sample of three bolts must be selected to calibrate a wrench. (By “representative sample” they mean bolts in the same condition as the ones that are about to be tightened.) The bolts are tensioned in a Skidmore-Wilhelm bolt tension calibrator on the site to measure (i.e., “calibrate”) how much torque it takes to get the bolts up to the correct tension. (That is, to a tension 5% higher than the specified minimum.) The wrench is then set to cut out at that torque (the wrench becomes “calibrated”), and then all similar bolts that day are installed to that torque after the joint is snugged first. Rotation during the tightening process must be limited to a specific value.

On the next day another set of torques is similarly established and the wrench(s) calibrated again. And so on. Tables of torque by bolt size and diameter are not applicable, and this entire method is not allowed in Canada. Actual results of tension in bolts produced by this method are acknowledged to be highly variable, even when this method is followed religiously, which is rarely the case.

Direct Tension Indicator (DTI)

DTI's are like little individual weigh scales, which measure the bolt tension developed during tightening, regardless of the torque resistance of the bolt. By far the simplest method, a DTI is put on one or the other end of all bolts, and after snugging the joint by partially (but not fully) compressing the DTI, all the DTI's are “crushed” to the point where a feeler gage cannot be inserted half way around.

DTI's are completely independent of the torque resistance of the bolt assembly, and because the compression of the DTI bumps can be seen by the eye, even without a feeler gage, bolt installers tend NOT to leave the bolts with insufficiently compressed DTI's. Inspection by using a feeler gage (on a sample of the bolts only) can be done by anyone at any time. If the DTI is put on the nut end of the bolt, tightening can be done by one person because it is not necessary to hold the bolt roll.

“Turn-of-Nut” or “Part Turn”

After snugging the joint, the bolt shank and nut is marked and then a specific amount of rotation is induced between the nut and the bolt. The amount of rotation differs for different bolt lengths and diameters and therefore must be known and understood by the bolt installers in advance. The success of the method is dependent on a correct snugging of the joint, and is dependent on the bolt head being held from turning so the bolt does not spin in the hole.

Two persons are therefore MANDATORY to execute this method correctly—one to hold the bolt from turning or “rolling” and the other person to operate the wrench.

Note that turn-of-nut does not work correctly when the steel surfaces are coated with a compressible coating such as high paint thickness or hot dipped galvanized zinc.

Twist-Off Bolts

This method usually defaults to “twist-off” bolts, sometimes called “tension-control” bolts. These assemblies function by calibrating the torque needed to twist off a splined extension manufactured into the bolt shank. Made correctly, the “twist-off” will occur at a bolt tension above the minimum required.

The main advantage of “twist-off” bolts is that they can be tightened from one side by one person, although bolt installers now realize that regular hex bolts and DTI's can also be installed one-side, one-man, too.

### SUMMARY

When used correctly, all four tensioning methods will produce correctly tensioned bolts, but all four methods differ in complexity and effectiveness.

### DESCRIPTION OF THE PRIOR ART

### Current Prior Art Manufacturing Process

The present invention deals primarily with twist-off (“twistoff”) fasteners as described generally above. The current manufacturing process for the twistoff nuts used in this construction technique is as follows. Raw material is purchased as round steel barstock in full lengths. The steel barstock is placed on a special rack so that it can be sorted to single pieces. The single pieces are then fed by rollers into a hot forging machine. The first step is to pass the steel barstock through an induction coil that heats the barstock red-hot. The next series of steps shears off a length of the barstock, forges impressions into and shapes the red-hot piece, and then pierces a hole through the top of the forged piece in its axial direction. The piece is still red-hot as it is conveyed away from the hot forging press. The hot-forged pieces are now referred to as “twistnuts.” The twistnuts are allowed to air-cool in large metal totes.

The specific purpose of these “twistnuts” is to shear off specially designed axial torque limiting members (“tangs”) on the top of casted iron bolts and therefore limit the amount of torque that can be applied to the bolt by the shear-failure of the tangs. While this “breakaway-bolt” or “twist-off” bolt technique has a wide range of applicability, it has significant application in the area of mechanical joint restraint systems that apply direct pressure to ductile cast iron and/or PVC pipe. In these circumstances it is critical to ensure that maximum torque levels are not exceeded so as to prevent possible damage to the pipe during installation. It is equally important to meet or exceed minimum torque requirements in this application to prevent restraint failure.

### Contrast to Present Invention

Within the context of the present invention, the steel twistnuts are replaced by an injection molded plastic nut that has one or more steel washer inserts. These washer(s) are stamped to a specific shape and dimension then placed in the mold immediately prior to the closing of the mold-in cycle. The washer is then substantially encapsulated in the plastic nut. The bottom of the washer is situated so that is in-line with the required “shear-plane” of the tangs (axial torque limiting members). The inside perimeter of the twistnut is the bearing surface required to shear the tangs. The outside perimeter of the washer/nut assembly are the main torque transfer points exerted by a socket wrench (or other torque generating device) used to turn the nut.

A major contrasting feature of many preferred embodiments of the present invention is the ability to eliminate a required and expensive manufacturing step in the assembly of the twistnut with the axial torque limiting member (“tang”) that is sheared off during field application. Normally, the twistnut is placed over the axial torque limiting member with the axial member protruding through the top of the twistnut. This protruding piece of the axial member is then rolled/flanged/mushroomed to force an impassable friction fit between the twistnut and the axial member. This friction fit assembly method is expensive to implement. In contrast, the present invention utilizes a press fit between the plastic support member encapsulant and the axial member. This is a cold-flow retaining mechanism. The plastic will maintain protection of the washer and the “nut” form, as well as include non-threaded retaining qualities to hold the twistnut in place during the transport and field application processes. The plastic also has the property in this application to hold the washer in the correct shear plane. In addition, the present invention also permits the twistnut to contain an impregnated/surface fastener to permit retention of the axial member as a substitute for or in addition to any press-fit that exists between the twistnut and the axial member.

### OBJECTIVES OF THE INVENTION

Accordingly, the objectives of the present invention are (among others) to circumvent the deficiencies in the prior art and affect the following objectives:

(1) To provide a retrofit to existing twistnuts that is fully compatible with existing twist-off bolt technologies.

(2) To reduce the manufacturing cost of current twistnuts.

(3) To enable higher volume production of twistnuts than is currently possible with the prior art.

(4) To reduce the number of manufacturing cycles necessary to produce twistnuts.

(5) To enable production of twistnuts without expensive and high maintenance Hatebur (or equivalent) hot forging machines.

(6) To reduce the weight and shipping costs associated with existing twistnuts by using a lighter material for twistnut construction, as well as reduce the energy requirements necessary to ship large quantities of these items via truck or other transport means.

(7) To reduce the capital equipment costs of producing twistnuts by eliminating the need for expensive hot forging equipment.

(8) To eliminate the energy requirements associated with hot forging equipment required to produce prior art twistnuts.

(9) To permit recycling of scrap twistnuts by making use of recyclable plastic in some invention embodiments.

(10) To improve the manufacturing cost efficiencies and performance associated with existing limiting torque bolt-nut assemblies such as those detailed generally in U.S. Pat. No. 4,627,774.

(11) To improve the manufacturing cost efficiencies and performance associated with existing pipe joint restrainer glands such as those detailed generally in U.S. Pat. No. 4,627,774.

(12) To improve the manufacturing cost efficiencies and performance associated with existing pipe junction holders such as those detailed generally in U.S. Pat. No. 4,092,036.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

### System Overview

The purpose of the present invention is to provide a method of implementing twist-off bolt connections without the need for forged twistoff nuts. The system as illustrated in FIGS. 5-12 generally consists of the following elements:

(a) a force bearing member having a central torque applicator and a plethora of injection inserts;

(b) a support member encapsulating the force bearing member and impregnating the injection inserts;

This basic system is constrained by the following criterion:

the torque application means permits rotation of an external axial member via the torque applicator and shearing of the member at a predefined torque value;

the support member has an external perimeter with a plethora of paired parallel surfaces that permit application of torque to the support member; and

the impregnation of the injection inserts by the support member permits transfer of torque from the paired parallel surfaces to the central torque applicator.

### Fabrication Method Overview (1600)

The present invention teaches a general methodology to fabricate a twistoff nut comprising the following basic steps as illustrated in FIG. 16 (1600):

(1) stamping a force bearing member having a central torque application and a plethora of injection inserts (1601); and

(2) encapsulating the force bearing member and impregnating the injection inserts to form a support member (1602);

(3) ejecting the torque shearing nut assembly from the injection mold (1603);

(4) repeating steps (1)-(3) for each torque shearing nut assembly (1604).

These basic steps mechanically link the force bearing member to the support member so as to form an integral twistoff nut system.

### Preferred Application Environment

One preferred commercial application for the present invention is in the construction and installation of restraint harnesses for ductile iron pipe bells. In this application (typically utilizing Megalug® brand or equivalent restraint harnesses), the present invention is specifically designed to directly replace the twistoff nut that is used to perform proper torque management of restraining ring fasteners.

Here the application demands that a restraining ring or gland be fitted to ductile cast iron pipe or PVC pipe. To prevent crushing or damage to the cast iron/PVC pipe, the use of some form of torque limiting in this application is mandatory. Typically a twistoff nut assembly that is manufactured with a Hatebur (or equivalent) hot forging machine is used for this purpose. This twistoff nut contains an outer surface that typically mates to a socket wrench or other torque generating device to permit torque transfer to the axial member on which the twistoff nut encompasses. The present invention is designed to be a direct replacement for these twistoff nuts, but at a significantly reduced price, lower cost of manufacture, lower cost of shipping, and reduce number and complexity of manufacturing steps.

### BRIEF DESCRIPTION OF THE DRAWINGS

For a fuller understanding of the advantages provided by the invention, reference should be made to the following detailed description together with the accompanying drawings wherein:

FIG. 1 illustrates a typical prior art application of twistoff nuts as applied to a mechanical joint restraint system;

FIG. 2 illustrates a typical application of the present invention in a preferred embodiment;

FIG. 3 illustrates a side view (0310) and end view (0320) of a typical S-Tang collar bolt impression (0300) for use with a twistnut assembly;

FIG. 4 illustrates a side view (0410) and end view (0420) of a typical Obround-Tang collar bolt impression (0400) for use with a twistnut assembly;

FIG. 5 illustrates an integrated sectional side view of a preferred embodiment of the present invention incorporating a hexagonal washer insert;

FIG. 6 illustrates a side view of a preferred embodiment of the present invention incorporating a hexagonal washer insert;

FIG. 7 illustrates an end view of a preferred embodiment of the present invention incorporating a hexagonal washer insert;

FIG. 8 illustrates a detailed view of a preferred embodiment a hexagonal washer insert used in some preferred embodiments of the present invention;

FIG. 9 illustrates an integrated sectional side view of a preferred embodiment of the present invention incorporating a hexagonal washer insert;

FIG. 10 illustrates a side view of a preferred embodiment of the present invention incorporating a hexagonal washer insert;

FIG. 11 illustrates an end view of a preferred embodiment of the present invention incorporating a hexagonal washer insert;

FIG. 12 illustrates a detailed view of a preferred embodiment hexagonal washer insert used in some preferred embodiments of the present invention;

FIG. 13 illustrates a detailed view of a preferred embodiment hexagonal tonsil washer insert used in some preferred embodiments of the present invention supporting Obround-Tang applications;

FIG. 14 illustrates a detailed view of a preferred embodiment hexagonal tonsil washer insert used in some preferred embodiments of the present invention supporting S-Tang applications;

FIG. 15 illustrates a detailed view of a preferred embodiment exterior molding used in some preferred embodiments of the present invention to prevent deformation of the twistnut surface thus allowing the use of standard nut drivers and the like for torque application;

FIG. 16 illustrates an exemplary fabrication methodology flowchart used in manufacturing a preferred embodiment of the present invention.

FIGS. 17-21 illustrate top views of an exemplary embodiment of the present invention as implemented in a twist-off nut assembly having an alignment washer and tonsil washer acting as a torque application means;

FIGS. 22-23 illustrate oblique views of an exemplary embodiment of the present invention as implemented in a twist-off nut assembly having an alignment washer and tonsil washer acting as a torque application means;

FIGS. 24-25 illustrate bottom views of an exemplary embodiment of the present invention as implemented in a twist-off nut assembly having an alignment washer and tonsil washer acting as a torque application means;

FIG. 26 illustrates an exemplary embodiment of an alignment washer used as a torque application means in conjunction with some preferred embodiments of the present invention;

FIG. 27 illustrates an exemplary embodiment of a tonsil washer used as a torque application and/or retaining means in conjunction with some preferred embodiments of the present invention;

FIGS. 28-31 illustrate oblique views of a exemplary embodiments of alignment and tonsil washers patterned for use as torque application and/or retaining means in conjunction with some preferred embodiments of the present invention as implemented in a twist-off nut assembly;

FIG. 32 illustrates an exemplary embodiment of the present invention with alignment and tonsil washers omitted for the purposes of viewing the internal twist-off nut cavity structures.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a TORQUE SHEARING NUT SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### System Overview (0100, 0200, 0300, 0400)

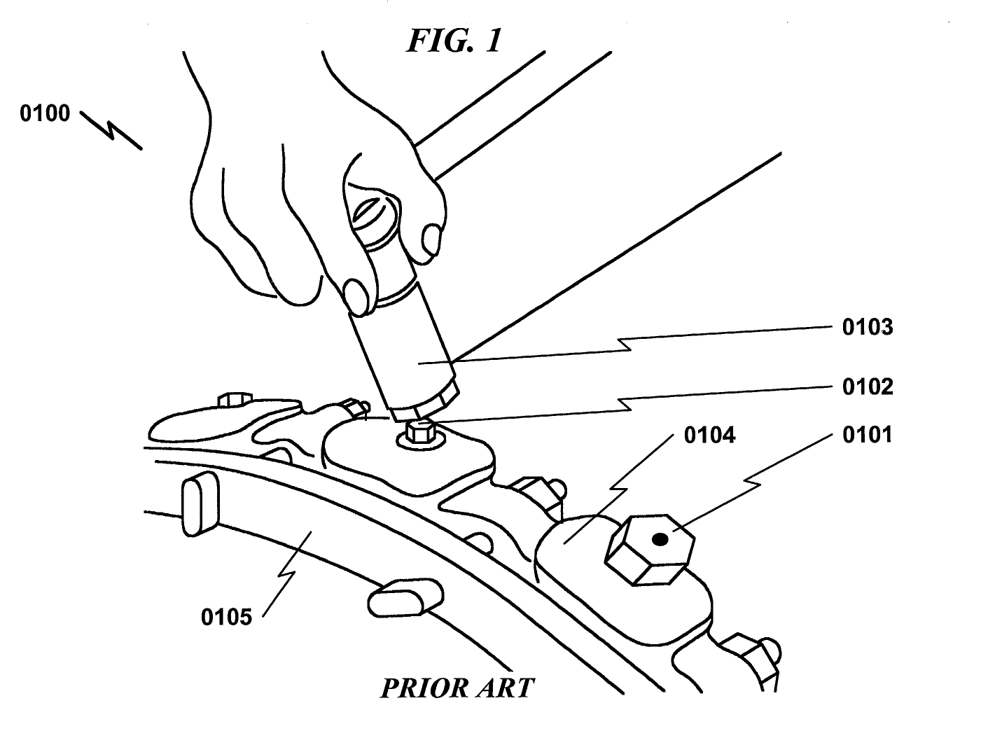

Referencing the prior art illustration of FIG. 1 (0100), the present invention application environment, while broad, has specific application in situations where twistoff nuts and the like are torqued to minimum torque values in the field. As illustrated in FIG. 1 (0101), the present invention twistnut technique generally begins with a twistnut assembly (0101) that is then torqued with a wrench (0103) or other implement to a specified torque level, at which point the twistnut (0101) detaches from an external axial member (0102), leaving the external axial member (0102).

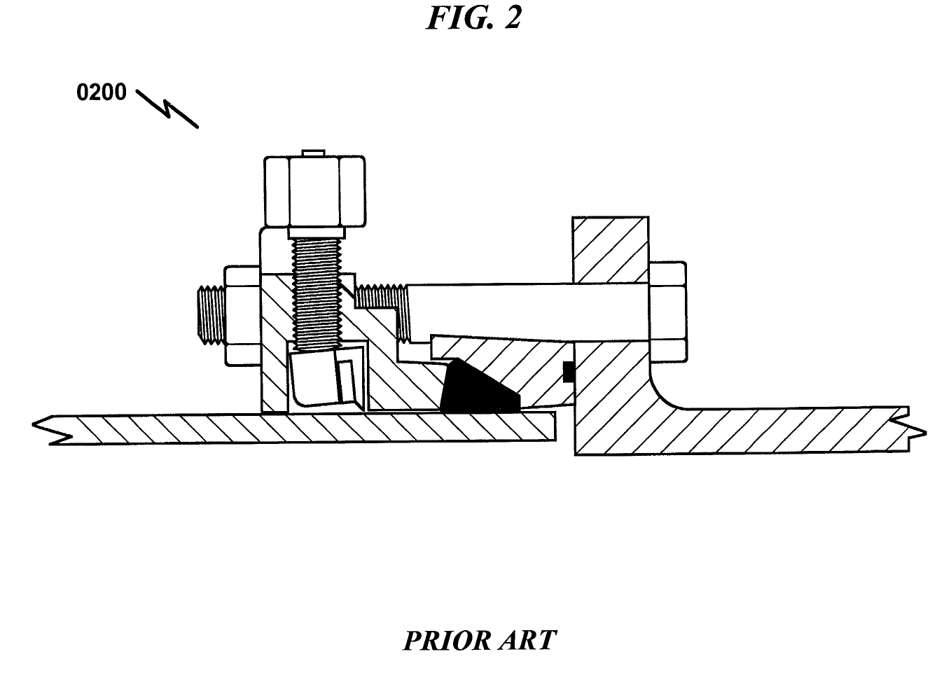

The exemplary system application illustrated in FIG. 1 (0100) is generally termed a “restraining flange adapter” system, typically sold under brand names such as MEGAFLANGE® and the like. A detail of this system application is illustrated in FIG. 2 (0200) wherein the twistnut is illustrated attached to the external axial member (also termed a “torque-limiting actuating screw” or the like). While the terminologies may vary, the purpose of the twistnut is to permit torque application to the external axial member until a portion of the member mechanically fails, permitting verification of proper torque to the connection system.

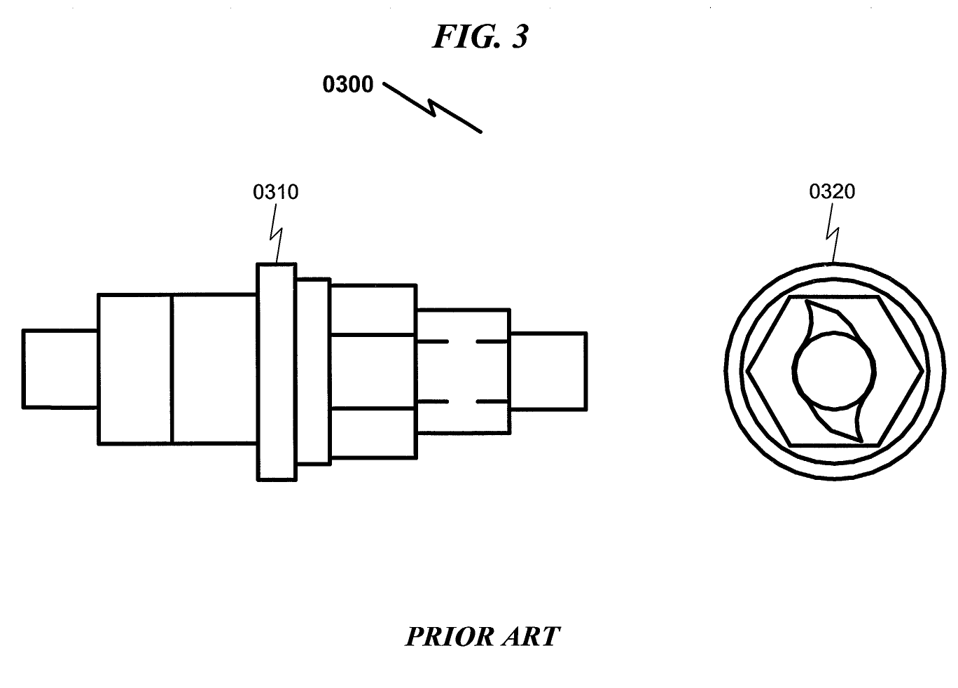

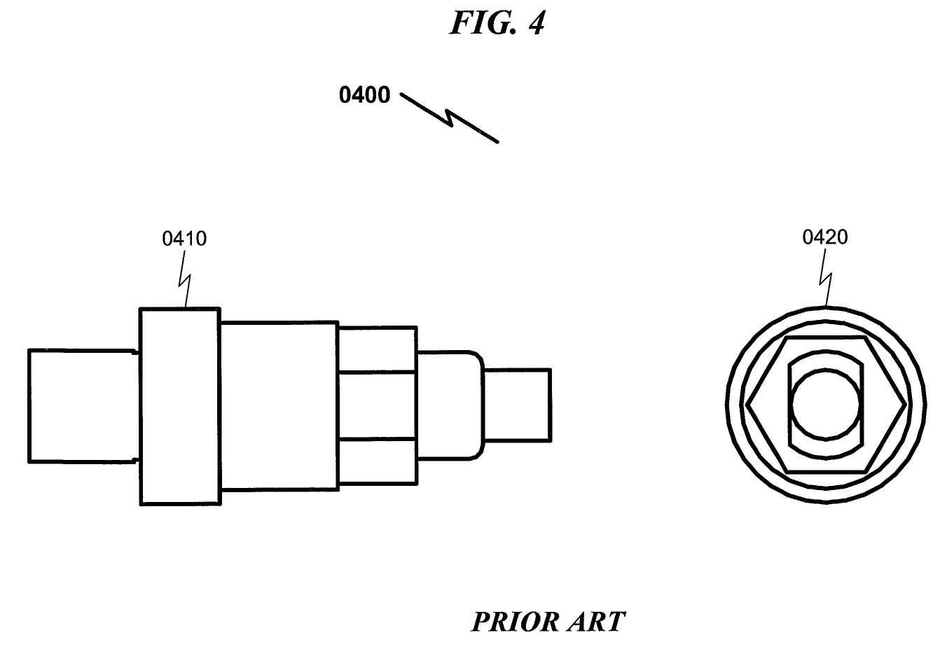

Generally, the prior art utilizes a casted collar bolt that is illustrated in FIG. 3 (0300) (for S-Tangs) and FIG. 4 (0400) (for Obround-Tangs). These exemplary collar bolt diagrams may be used within the context of the present invention to generate a plastic mold that conforms to the twistnut dimensions typically used by the prior art. The key difference in the present invention is that this new support structure may be constructed of plastic or some other low-cost material rather than requiring hot-forging as in the prior art.

Given that this new support material may not have the strength of existing forged twistnuts, a metallic or other hard insert is placed inside the support material. This hard insert is substantially encapsulated by the support material and provides the mechanical strength to permit torque application to the external axial member as illustrated in FIG. 1 (0102).

Exemplary System Embodiment (0500, 0600, 0700, 0800)

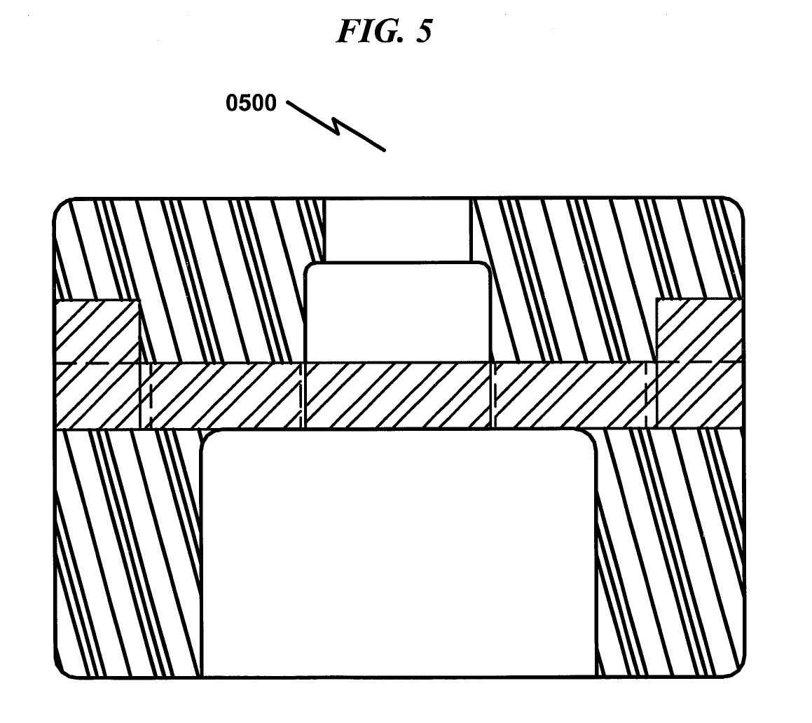

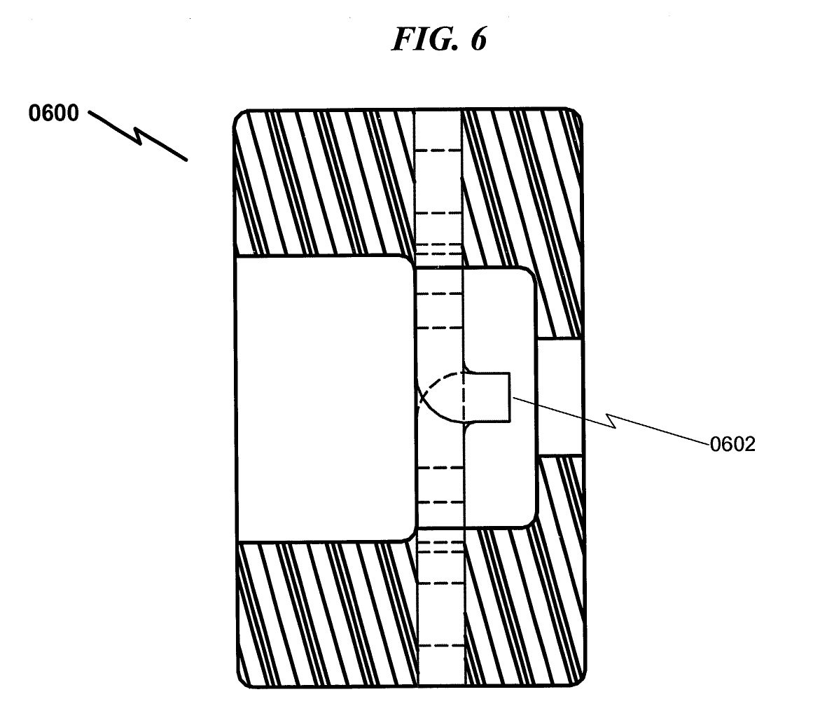

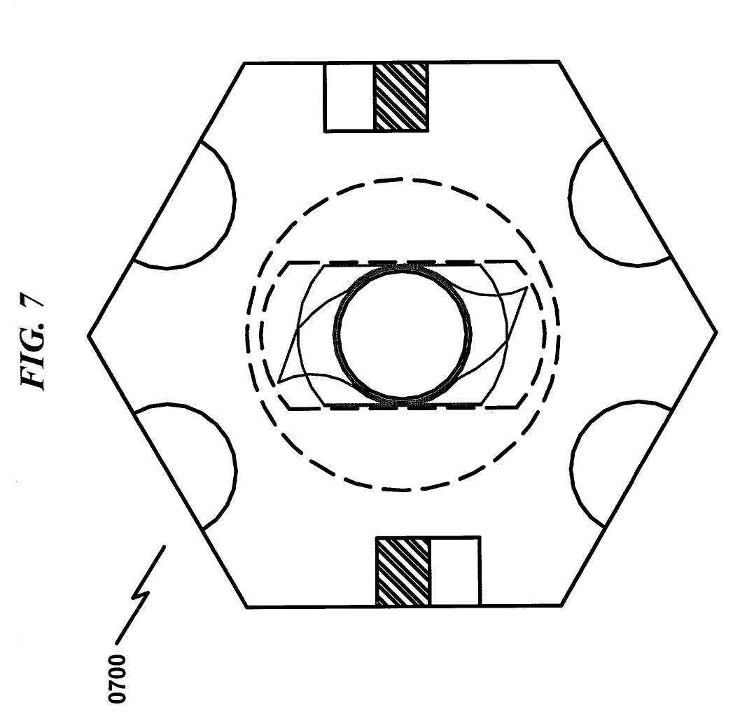

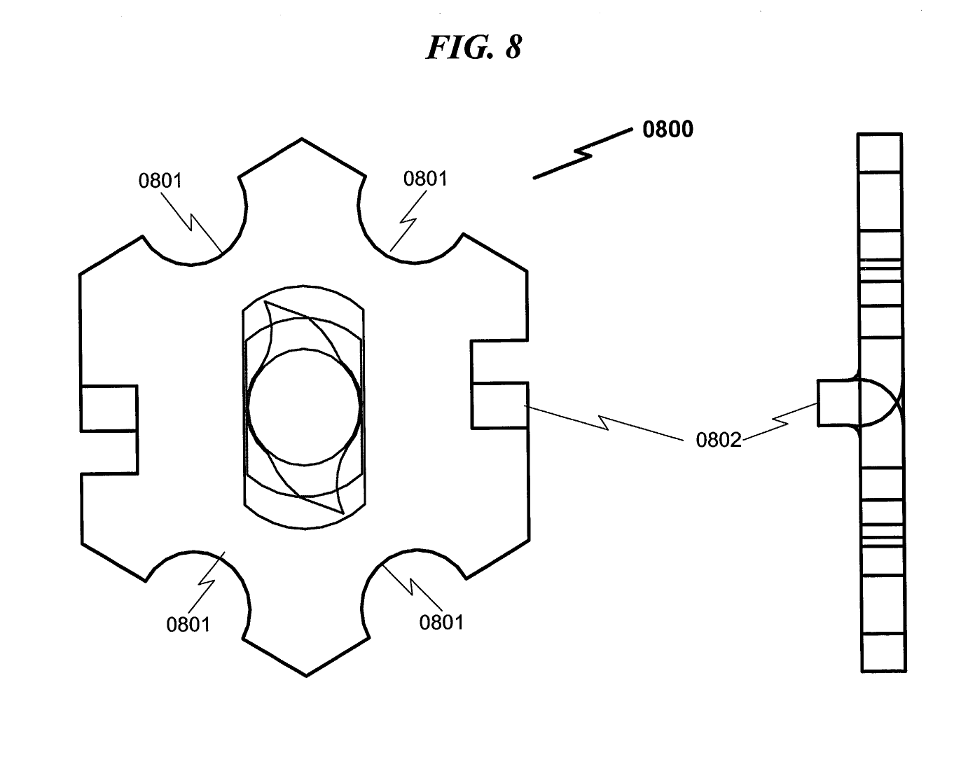

The present invention may be embodied in many forms, but one preferred embodiment style is illustrated in FIGS. 5-8 (0500, 0600, 0700, 0800) which illustrate a side view of the hybrid twistnut assembly (0500), a detailed side view illustrating an exemplary washer insert (0600), a detailed end view of the assembled twistnut (0700), and a detailed end/side view of the exemplary washer insert (0800).

It is significant to note that there are a wide variety of variations in construction of the washer insert that are possible in these configurations. Here the washer insert is illustrated as having a plethora of semi-circular injection inserts (0801) which permit plastic or other encapsulant to surround and mate to the washer insert. Additionally, one or more tabs (0602, 0802) may be formed in the washer insert to permit greater adhesion and contact with the support material (i.e., plastic, etc.). This may permit greater torque transfer from the support material (i.e., plastic, etc.) to the torque bearing washer insert. These tabs (0602, 0802) are normally formed perpendicular to the plane of the washer insert, but this is not critical. While the tabs may be oriented in either perpendicular direction, in some embodiments they may be omitted completely. Furthermore, the tabs (0602, 0802) may be oriented in any direction, not necessarily one that is perpendicular to the washer plane. Note that these tabs (0602, 0802) are optional and may not be present in all embodiments.

### Exemplary System Embodiment (0900, 1000, 1100, 1200)

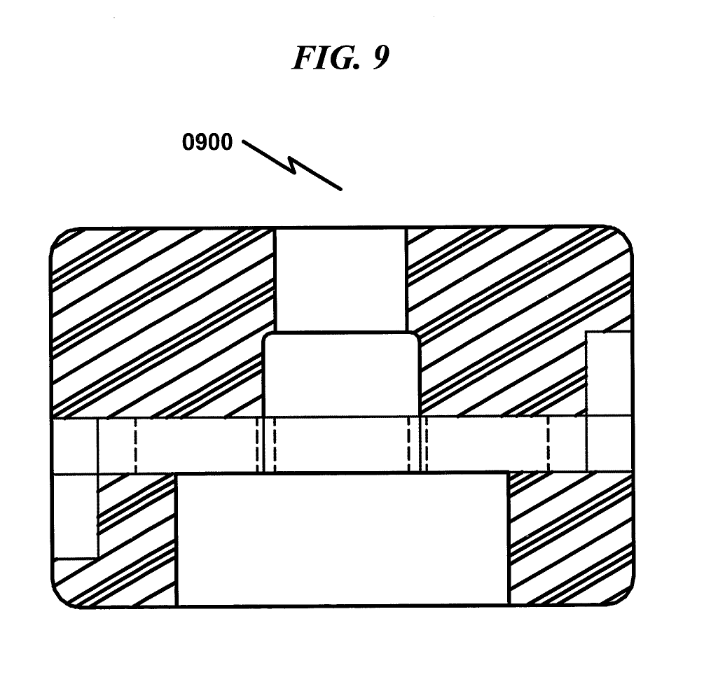

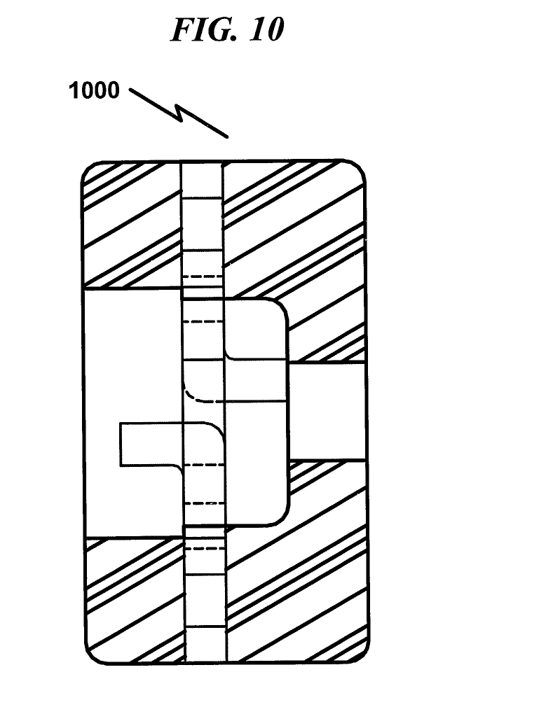

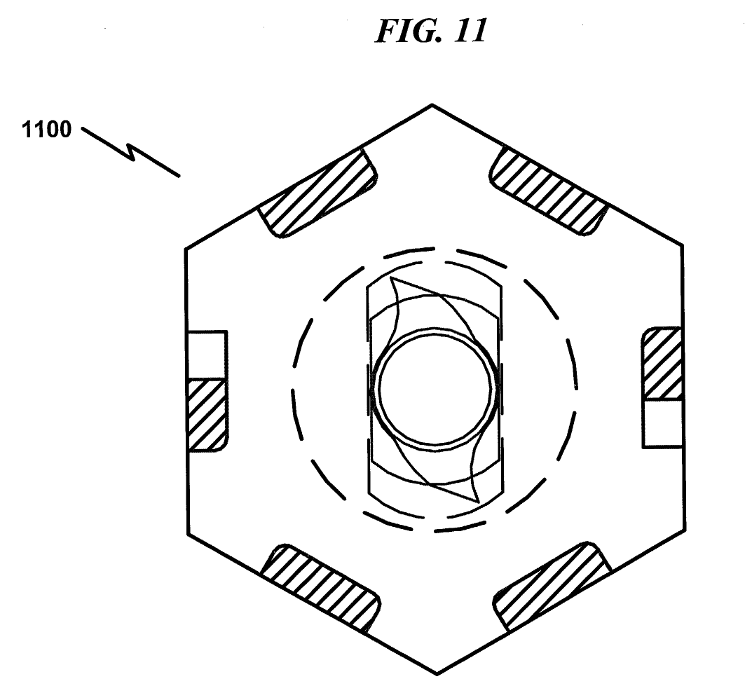

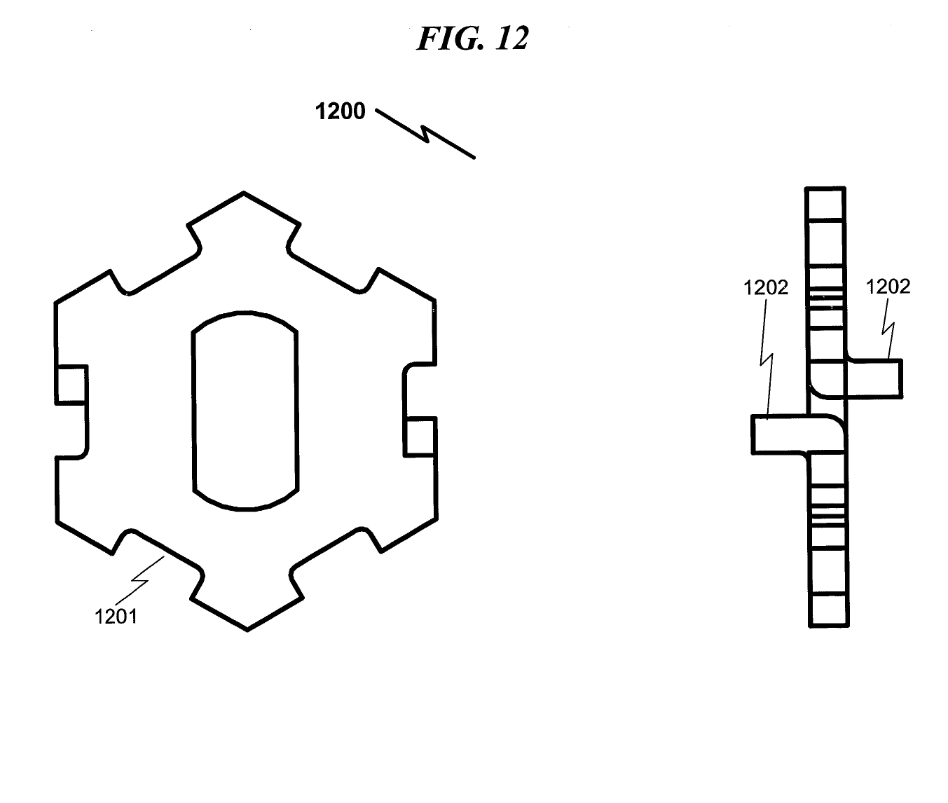

The present invention may be embodied in many forms, but one preferred embodiment style is illustrated in FIGS. 9-12 (0900, 1000, 1100, 1200) which illustrate a side view of the hybrid twistnut assembly (0900), a detailed side view illustrating an exemplary washer insert (1000), a detailed end view of the assembled twistnut (1100), and a detailed end/side view of the exemplary washer insert (1200).

It is significant to note that there are a wide variety of variations in construction of the washer insert that are possible in these configurations. In these illustrated embodiments the washer insert is illustrated as having a plethora of rectangular injection inserts (1201) which permit plastic or other encapsulant to surround and mate to the washer insert. Additionally, one or more tabs (1202) may be formed in the washer insert to permit greater adhesion and contact with the support material (i.e., plastic, etc.). This may permit greater torque transfer from the support material (i.e., plastic, etc.) to the torque bearing washer insert. These tabs (1202) are normally formed perpendicular to the plane of the washer insert, but this is not critical. Furthermore, the tabs (1202) may be oriented in any direction, not necessarily one that is perpendicular to the washer plane. Note that these tabs (1202) are optional and may not be present in all embodiments. The dimension and radii of these optional tabs is generally as allowed by the material used for the washer.

### Preferred Exemplary System Embodiments

Several preferred exemplary system embodiments are possible, with the variations in these embodiments taking the form of variations in the selection and construction of the force bearing member means, central torque application means and/or the support member means. These preferred system variations will now be considered in detail.

Washer Material Variations

While mild steel may be a suitable material for the force bearing member/central torque application means, the following materials may also be more optimal in some system configurations:

one or more washers using grade 50-100 high strength/low alloy (HSLA) steel (depending on the desired maximum torque value required);

one or more washers using carbon steel heat treated (e.g., 1050 carbon steel) to a tensile strength as needed for the application (this material may have a tensile strength on the order of 150,000 PSI or greater); or

one or more washers using an ultra-high strength steel such as MartINsite® steel (manufactured by Inland Steel) or an equivalent (this material may have a tensile strength on the order of 190,000 PSI). MartINsite® is an ultra-high strength, fracture tough, cold rolled sheet steel produced as a low carbon alloy free material. While traditional high strength products develop strength from alloying elements, MartINsite®'s strength is produced by extremely fast water quenching from an elevated austenitic temperature range which results in an autotempered “martensitic” structure. MartINsite 's ultra-high strength allows the use of reduced gauges and lighter sections when compared to regular carbon steels. Considerable savings in material and processing costs can be realized over high alloy or spring steels.

While the MartINsite steel would seem to have a significant advantage in this application and therefore be preferable, all options mentioned (and their functional equivalents) would also be suitable in this application. In some preferred embodiments, the M190 grade of MartINsite may be optimal given its cost, thickness, and material properties. Note that MartINsite® may in many applications be replaced by an equivalent ultra-high strength steel (UHSS).

Note that while heat treated carbon steel (e.g., 1050 carbon steel) is a preferred system embodiment, other heat treatable steels may also be suitable in many applications. One suitable variation of this configuration is a SAE/ANSI 1050 washer having a Rockwell hardness number of 39 on the c-scale (Rc 39) and a tensile strength of 210,000 PSI.

Washer Insert Variations—Obround-Tang (1300, 1400)

Tonsil-Washer Inserts (1310, 1320, 1410, 1420)

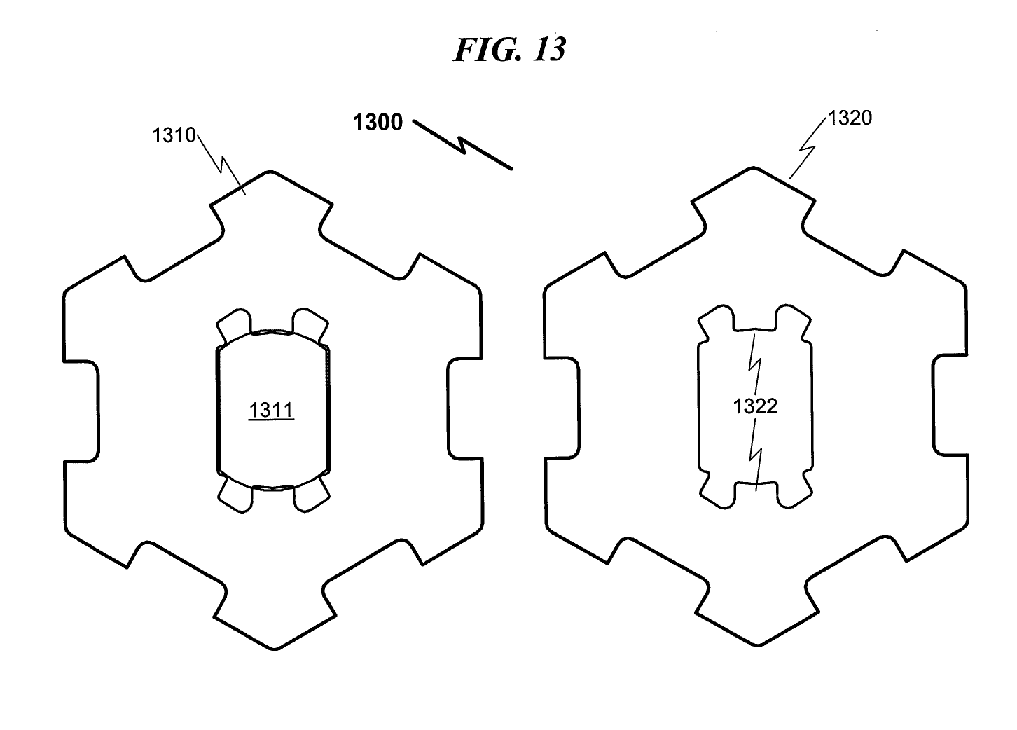

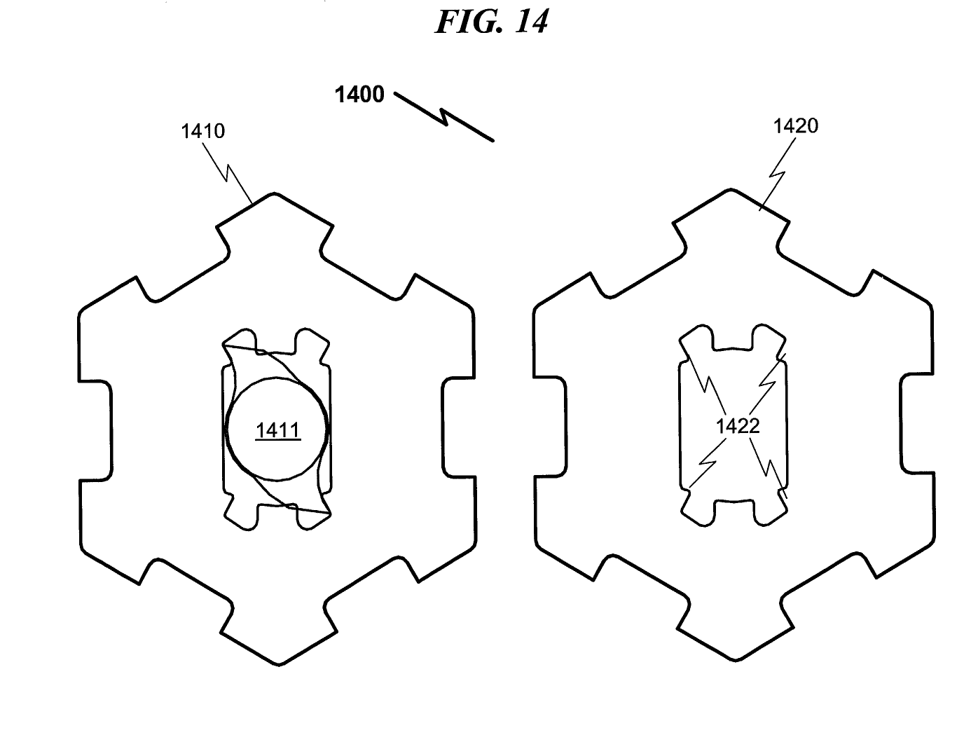

When extreme physical and/or rough handling of the Plastic Torque Shearing Nut is anticipated, a “Tonsil-Washer” insert (generally constructed of steel) as illustrated in FIG. 13 (1310, 1320) and FIG. 14 (1410, 1420) may be utilized to ensure that the Plastic Torque Shearing Nut cannot be accidentally knocked off or pulled off. The perimeter of the Tonsil-Washer may be the same as the other steel washer inserts but the inside perimeter is designed to be a non-threaded fastener.

The use of tonsils (1322) permit gripping of Obround-Tangs (1311) while the use of end-corner extensions (1422) permits gripping of S-Tangs (1411) when used in conjunction with the tonsil washer end corners (1322). A unique feature of the washer embodiments illustrated in FIG. 13 (1300) and FIG. 14 (1400) is the ability to grip both Obround-Tangs and S-Tangs with a single washer, permitting the use of a single twistnut assembly for both types of shaft tangs. This ability to permit gripping of both S-Tangs (1411) and Obround-Tangs (1311) with the same structure is not present within the prior art. More detail of exemplary S-Tang (0310, 0320) and Obround-Tang (0410, 0420) structures is illustrated in FIG. 3 (0300) and FIG. 4 (0400) respectively.

Obround-Tang Tonsil Washer Action (1300)

Non-threaded fastening to the Obround-Tang (1310, 1320) is accomplished by the bottom or “end” of each “tonsil,” (1322) on a steel “Tonsil-Washer,” insert, located opposite of one another, having an interference fit with the Obround-Tang. When the Plastic Torque Shearing Nut is pressed onto the tang (1311), the tonsils (1322) tend to give way to the tang and bite into the tang having enough memory inherent in the steel to maintain a constant and sure fastening. The bottoms of the small protrusions located immediately adjacent to the ends of the tonsils are centering-devices, as they hold the Obround-Tang in the center of the steel “Tonsil-Washer” insert ensuring a relatively even bite of the tonsils on the tang. The more pressure that is applied to pull the Plastic Torque Shearing Nut off of the Obround-Tang, the more the tonsils bite into the tang.

S-Tang Tonsil Washer Action (1400)

Non-threaded fastening to the S-Tang (1410, 1420) is accomplished in much the same principal as the Obround-Tang. However, in the case of the S-Tang, the bottom corners or “end-corners” (1422) of each “tonsil” on a steel “Tonsil-Washer” insert, located diagonally opposite of one another, have an interference fit with the clockwise face of the “S” on the S-Tang (1411) (keeping in mind that the “S” on the S-Tang is actually a backwards “S”)

The faces of the small protrusions located immediately adjacent to the ends of the tonsils are bearing surfaces for the counterclockwise side of the “S”. As the end-corners of the tonsils bite into the clockwise side of the “S”, the “S” is forced against the faces of the protrusions and hence, become a bearing surface. The faces of the protrusions have the same radius as the counterclockwise face of the “S”. Without the protrusions, the tips or “points” on either ends of the “S” is merely peeled off during the press-on stage of assembly to the collarbolt. This peeling-action alleviates the interference fit and prevents the tonsils from biting securely enough for extreme, rough handling. With the protrusions in place, the Plastic Torque Shearing Nut is pressed onto the S-Tang (1411). The tonsil end-corners tend to give way to the tang and bite into the tang having enough memory inherent in the steel to maintain a constant and sure fastening. The more pressure applied to pull the Plastic Torque Shearing Nut off of the S-Tang, the more the tonsils bite into the tang.

Collarbolt Assembly Locating Feature

When assembling the Plastic Torque Shearing Nut to the collarbolt, a quick directional locating feature may be necessary to make assembly fast and, hence, low cost. When the Plastic Torque Shearing Nut is placed on top of the collarbolt nib, the round column on top of the tang, the nib stabs immediately past the steel washer inserts and into a clearance, in-set region just above the steel washer inserts. The in-set is just deep enough to allow the top of the tang to locate within the inside perimeter of the bottom steel washer insert or just the bottom of the steel washer insert in a single insert Plastic Torque Shearing Nut.

Euro-Design on Top of the Plastic Torque Shearing Nut (1510, 1520, 1530)

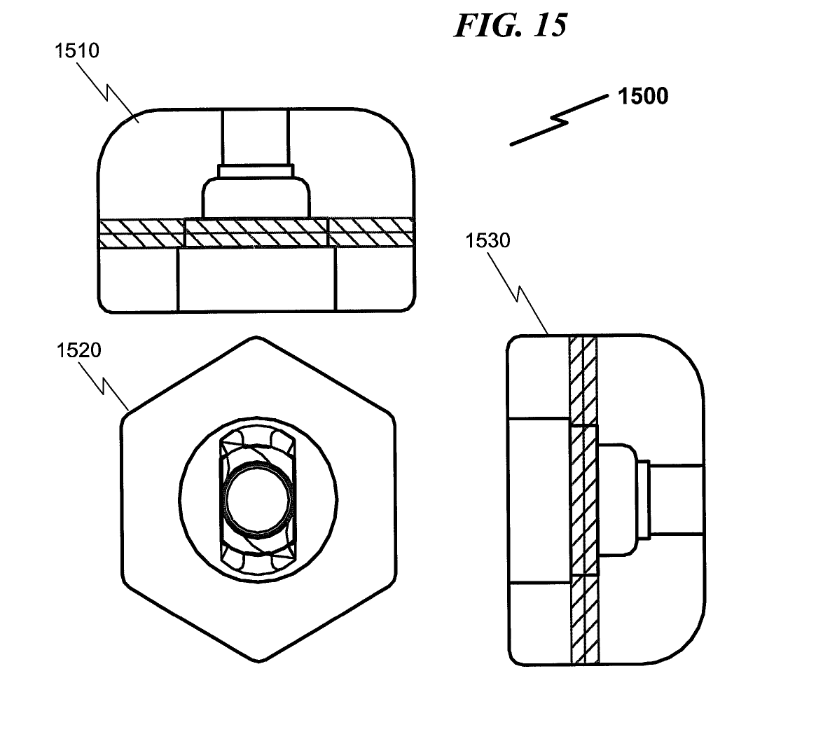

The present invention may be constructed using a large radius edge chamfer as illustrated in the exemplary embodiments in FIG. 15 (1510, 1520, 1530). The large radius around the top perimeter edge of the Plastic Torque Shearing Nut is not just for appearance. This allows for a greater non-deforming impact surface. When the Plastic Torque Shearing Nut is subjected to large impact forces around the top perimeter, the plastic tends to want to flow instead of break. With the large radius, the impact tends to just lessen (or flatten) the radius rather than flow. Whereas with a small radius around the top perimeter of the Plastic Torque Shearing Nut, the plastic can flow beyond the outside perimeter of the nut hindering the ready placement a socket wrench.

Multiple Washer Configuration Variations (1510, 1520, 1530)

Note that in the above variations it is explicitly mentioned that the washer configurations while depicted in FIGS. 5,6,7,8,9,10,11,12 as single washer/plates (0800, 1200) may also be constructed of multiple washer/plates stamped out of material as detailed within this disclosure. This approach may be used with any of the system configurations mentioned herein. An exemplary embodiment of this variant is illustrated in FIG. 15 (1510, 1520, 1530).

Reasons for this construction approach may vary. For example, the material used may only be readily available in thin stock (e.g., 0.058-inch thick) and the application may require a tensile strength requiring stacking of the washer material for proper function of the system. Additionally, issues regarding the feasibility of stamping thick washer members may also dictate the use of multiple washer/plate members.

Finally, in some preferred embodiments one of the washers may serve as an alignment guide for the torque-bearing shaft while another washer may be used to grip the shaft using a press-fit or tonsil-type deformation of the washer. This multi-level construction permits rapid assembly while providing secure fastening of the twistnut assembly to the torque-bearing shaft tang and simultaneously may provide the capability of fastening to Obround-Tang and/or S-Tang shaft tang configurations.

Washer Tab Configuration Variations

While the washer configurations depicted in FIGS. 5,6,7,8,9,10,11,12 indicate perpendicular tabs (0602, 0802, 1202) to aid in the transfer of torque from the outer parallel surfaces of the washer to the central torque application means, there is no requirement that these perpendicular tabs be present for proper operation of the invention in many preferred embodiments. The use of these perpendicular tabs will be highly dependent on the system application and the material used for the support member means.

Support Member Means Variations

The present invention is particularly amenable to the use of various plastics as the primary material for use in the support member means. Some exemplary variations for use with the support member means will now be discussed.

Thermoplastic Rubber (Vyram®)

Various types of thermoplastic rubber well known to those skilled in the art are suitable for this application. One particularly suitable thermoplastic for some preferred embodiments is Vyram®, available from Advanced Elastomer Systems, L.P., 388 S. Main Street, Akron, Ohio 44311, tel 330-849-5000. Specifically, the use of Vyram® 9103-45 is anticipated in this application by the present invention.

This particular type of thermoplastic rubber is temperature and oil resistant and is as good as or better than mid-to-lower-end EPDM, SBR and natural rubber. Vyram® 9000 rubber provides properties that are superior to those of the thermoplastic olefins (TPOs) which have little or no crosslinking (vulcanization) of their rubber phases. Both Vyram® and Santoprene® rubbers are good candidates for replacing EPDM and neoprene (polychloroprene) thermoset rubbers, with Vyram® rubber being the cost effective candidate when replacing SBR and low-end EPDM thermoset compounds. Vyram® rubber can be considered in applications where styrenic thermoplastic materials such as SBS and SEBS are being used or are being considered for use. Vyram® rubber can often meet or improve the balance of cost and performance in these applications.

One of the major economic advantages of Vyram® 9000 rubber over thermoset rubber is its recyclability; clean regrind can be used multiple times without significantly affecting its properties. When used with the present invention, this particular type of rubber product may reduce waste products normally associated with twistoff nuts and the like by permitting recycling of the twistoff nut itself. While initial cost of Vyram® 9103-45 is in the range of US$1.49/lb versus US$0.042/lb for polypropylene (resulting in an overall cost differential of approximately US$0.035 per twistoff nut assembly in an exemplary application), this initial cost differential may be offset by the ability to readily recycle the Vyram® material from the twistoff nut that is normally scrapped once the torque shearing operation is complete.

Polyamides (Nylon)

Various types of high-strength polyamides (nylon) well known to those skilled in the art are suitable for this application. Polyamides are available in a variety of grades, including general-purpose, which can be unreinforced or reinforced; impact-modified grades, unreinforced or reinforced, but with superior impact resistance; and reduced moisture grades, available as glass- and/or mineral-reinforced or both reinforced and impact modified. There are also flame-retardant grades and grades for medical devices.

Polypropylene (PP)

Additionally, the use of plastics such as polypropylene (PP) and its variant forms are suitable for this application. Polypropylene has a range of molecular weights, copolymers, blends, alloys, and filled or reinforced polymers. The homopolymer form of PP is the most frequently used since it is ideal for a wide range of activities due to its high heat resistance, tensile strength and good rigidity. Homopolymers compounded with fiberglass, calcium carbonate, talc, and other mineral fibers can provide cost effective, lower density materials for certain injection molding applications; they are available with a filler loading from 10 to 40%. Significant increases in heat distortion, tensile strength, and modulus can be obtained with glass-filled, talc-filled, and, to a lesser amount, with calcium carbonate-filled systems. Random copolymers and heterophasic copolymers have also been developed to further broaden the spectrum of the use of polypropylene.

With respect to a preferred system embodiment, polypropylene may have a significant cost advantage over the use of nylon. For example, a typical cost for nylon might be US$1.30/lb, whereas the cost for polypropylene might be only US$0.40/lb (and range as low as US$0.25/lb), yielding an effective cost savings of 3× to 4× of polypropylene over nylon.

High-Density Polyethylene (HDPE)

Finally, the use of plastics such as high-density polyethylene (HDPE) and its variant forms are suitable for this application. There are three basic types of polyethylene (PE) resins: low-density PE (LDPE), linear low-density PE (LDPE), and high-density PE (HDPE). HDPE has advantages in this application due to its light weight, excellent chemical resistance, ease of processing, and relatively low cost. One skilled in the art will be familiar with the many variations of HDPE and their applicability to the present invention given the teachings presented in this document.

### Exemplary Assembly Views

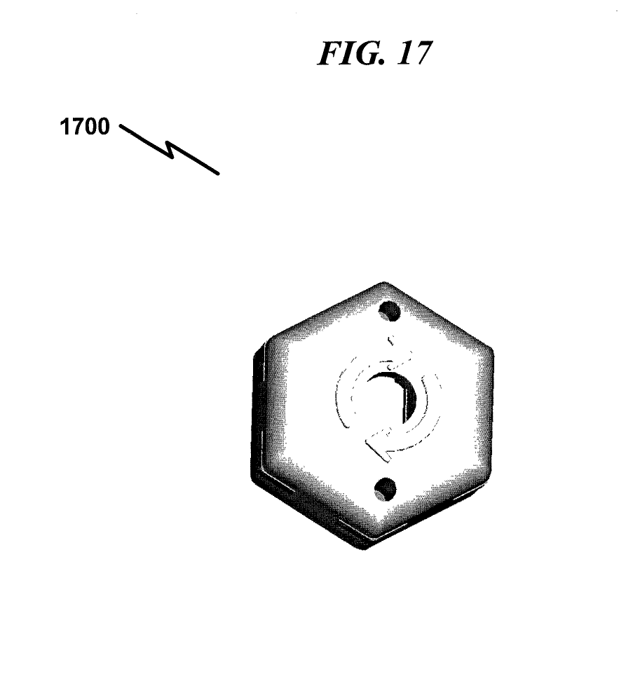

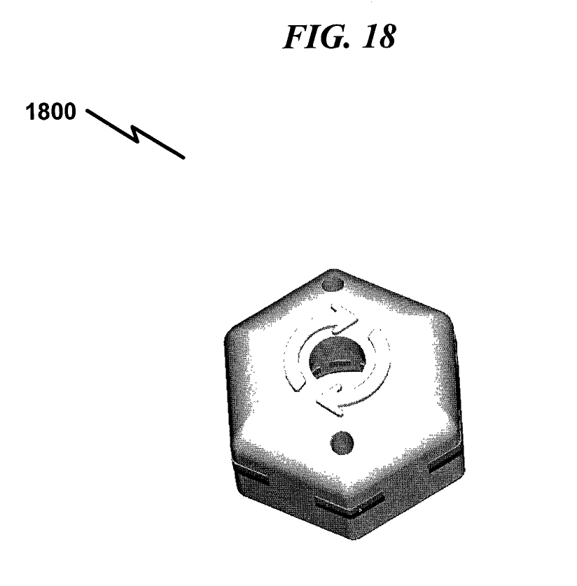

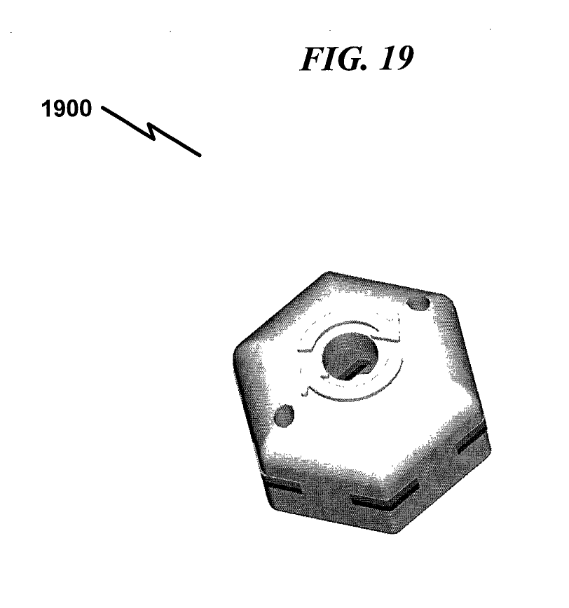

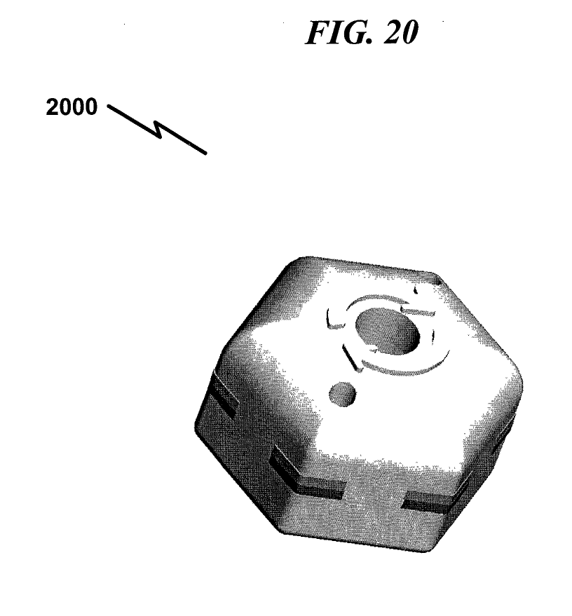

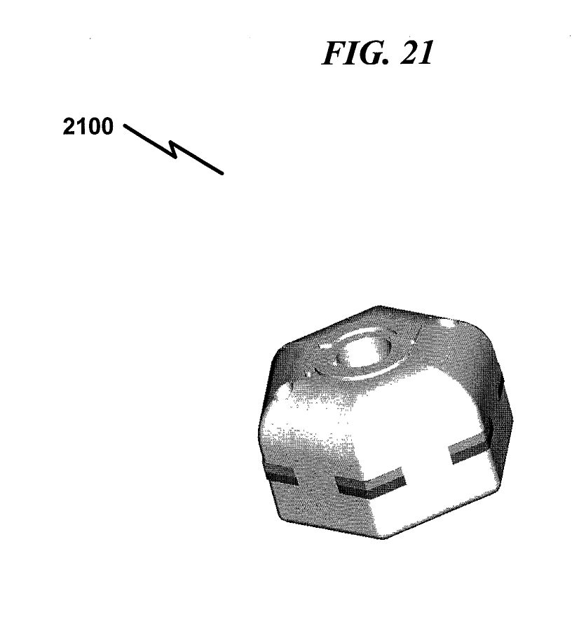

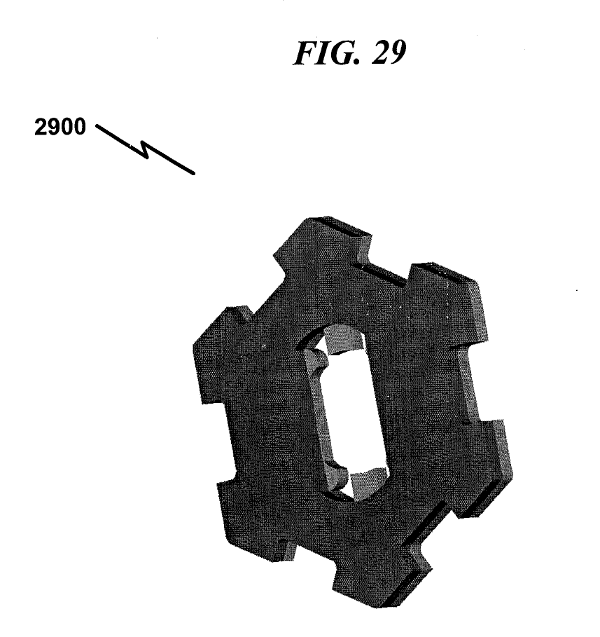

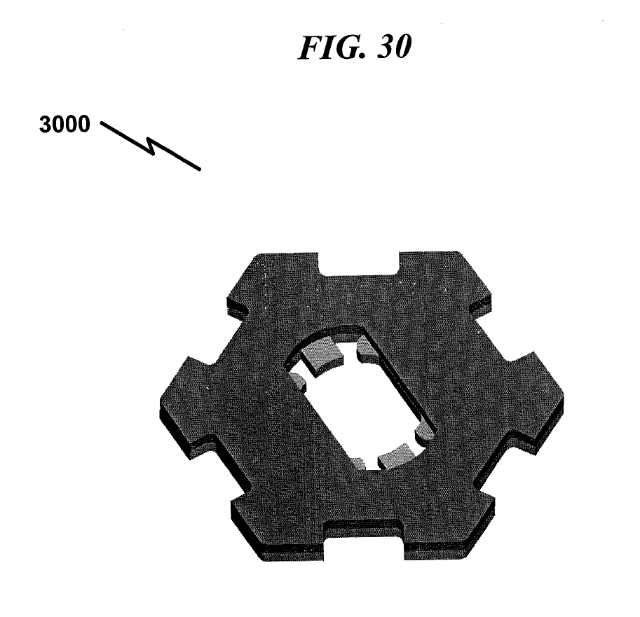

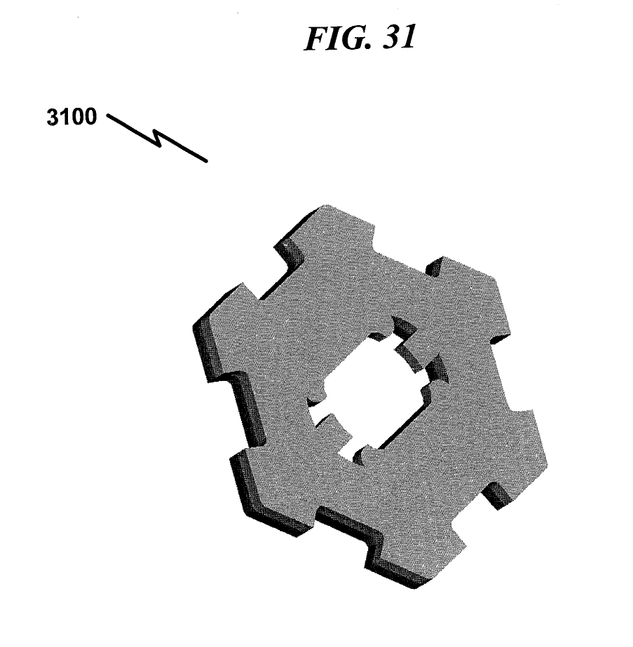

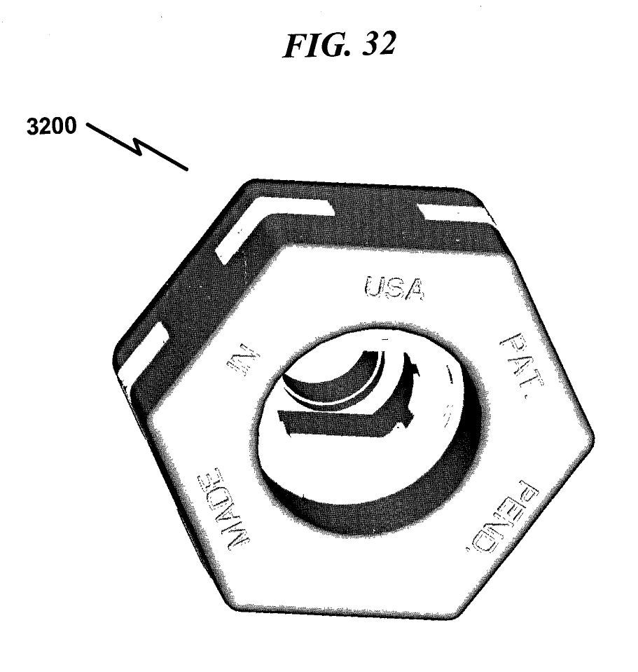

While the present invention is amenable to construction in a wide variety of forms, FIGS. 17-32 (1700, 1800, 1900, 2000, 2100, 2200, 2300, 2400, 2500, 2600, 2700, 2800, 2900, 3000, 3100, 3200) provide some assembly detail as to variations that are in some circumstances preferred.

Top Views (1700, 1800, 1900, 2000, 2100)

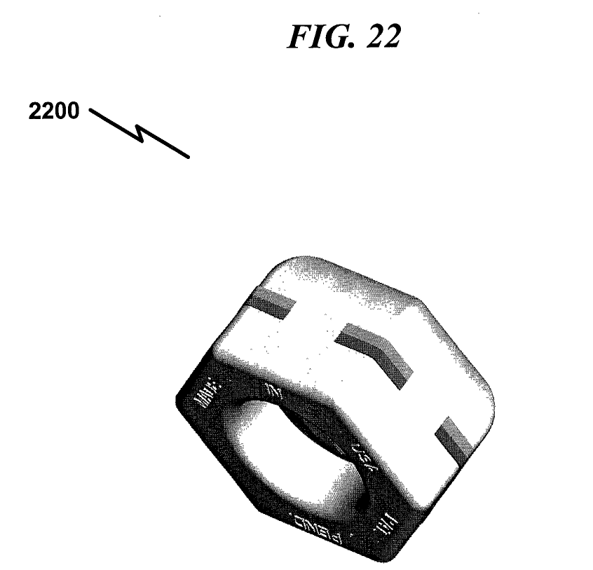

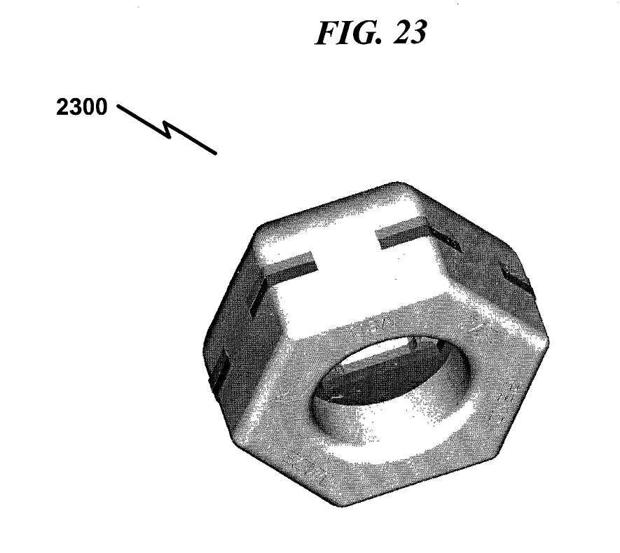

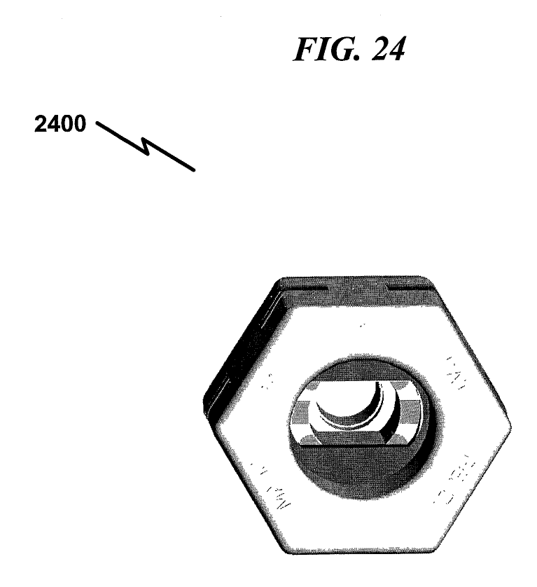

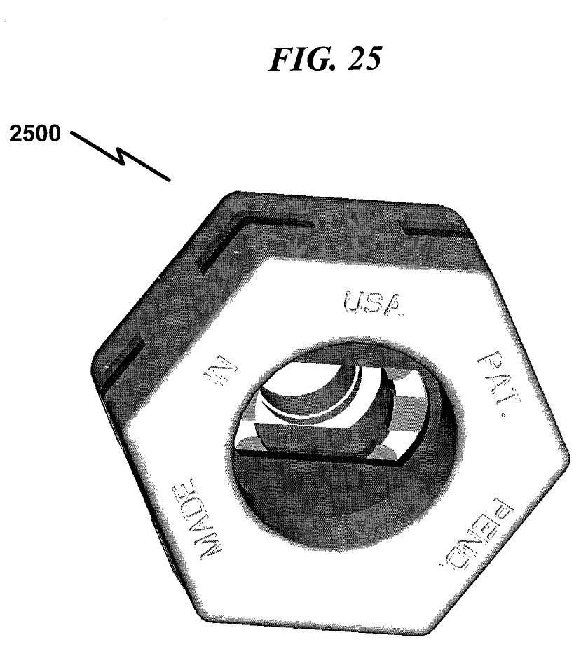

FIGS. 17-21 (1700, 1800, 1900, 2000, 2100) provide top views of an exemplary embodiment of the invention as embodied as a twist-off nut assembly, with FIGS. 22-23 (2200, 2300) providing corresponding oblique views, and FIGS. 24-25 (2400, 2500) providing corresponding bottom views of the same preferred invention embodiment. FIG. 25 (2500) is of particular note as it provides interior cavity detail that illustrates the use of an alignment and tonsil washer.

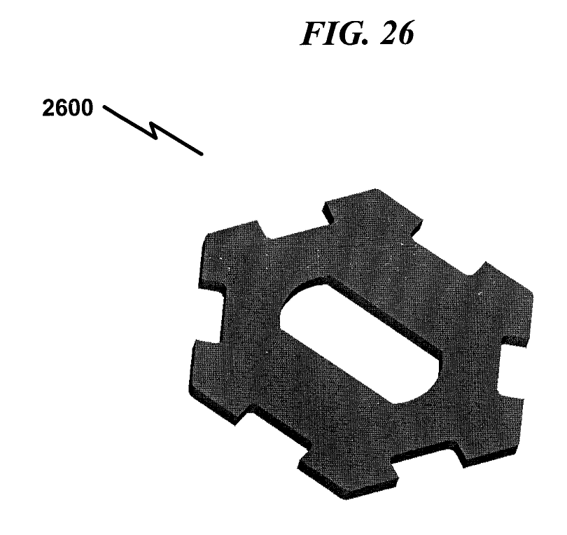

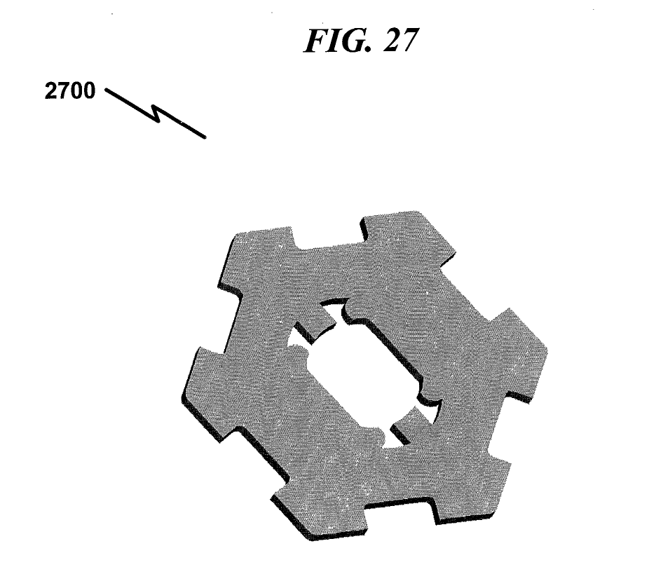

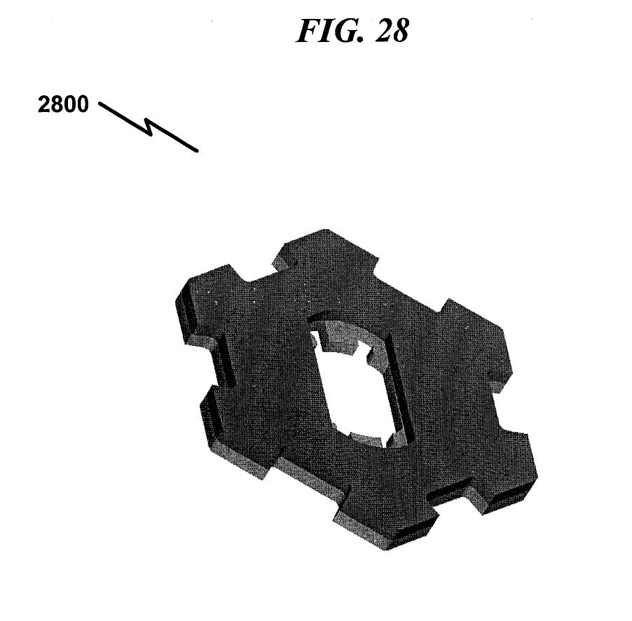

FIG. 26 (2600) illustrates an exemplary alignment washer used to align the S-Tang or Obround-Tang with FIG. 27 (2700) illustrating an exemplary tonsil washer used to grip the S-Tang or Obround-Tang shaft. As illustrated in FIGS. 17-25 (1700, 1800, 1900, 2000, 2100, 2200, 2300, 2400, 2500), these washers are both used in this embodiment and are stacked on top of one another as illustrated generally in the exemplary views of FIGS. 28-31 (2800, 2900, 3000, 3100) before being substantially encapsulated by the support member means.

### System Variations

The present invention anticipates a wide variety of variations in the basic theme of construction, including but not limited to the following:

The use of plastic for the support member.

The use of a fastener at the end of the external axial member to retain the axial member to the support member.

The use of a press-fit between the external axial member and the support member to connect these two elements prior to and during the torque application process.

The use of semi-circular and/or rectangular injection inserts.

The use of holes in the force bearing member as injection inserts. These may be drilled, punched, or otherwise formed as one skilled in the art will readily recognize.

The use of a washer as the force bearing member in the support structure, as well as the use of steel and other materials for this washer.

The use of hexagonal, square, Torx® (a type of spline), spline, and other polygonal and/or radial shapes to form the support structure. Generally any structure that permits torque application is amenable to use with the present invention.

The use of a central torque application means having parallel sides connected to semi-circular ends, as well as the use of rectangular shapes for this structure.

The use of a central torque application means having sides in the form of a regular polygon.

The use of tabs (perpendicular to the plane of the washer insert or otherwise) to aid in the transfer of torque from the support member to the central torque application means. These tabs may be in any orientation and may have opposing orientations.

The use of pins or other injection molding aids to help support the force bearing member during the injection molding process.

Dimensions in any illustrated embodiments are only exemplary of potential implementations of the invention.

One skilled in the art will no doubt be able to take the teachings of the present invention and expand this list considerably.

### Exemplary Cost Savings

The present invention has significant cost savings over the prior art. This cost reduction for the present invention in manufacturing approaches 50% over the prior art, and does not include the cost savings associated with shipping. Since the present invention is significantly lighter than the prior art, shipping costs (and associated transport fuel consumption) are significantly reduced.

### Restraining Gland Application

The present invention specifically anticipates the use of the present invention in the context of pipe restraining glands as detailed generally in U.S. Pat. No. 4,092,036 for PIPE JUNCTION HOLDER issued May 30, 1978 to Toshiyuki Sato and Hideo Edo, and initially assigned to Kabushiki Kaisha Suiken of Osaka, Japan and U.S. Pat. No. 4,568,112 for PIPE JOINT RESTRAINER GLANDS issued Feb. 4, 1986 to Earl C. Bradley, Jr., Jack Burkholder, Earl F. Bullock and assigned to EBBA [sic] Iron Inc. of Eastland, Tex., USA. Specifically, the present invention anticipates that torque bolt-nut assemblies used in these applications will be dramatically improved by using the teachings of the present invention.

A general example of this type of torque bolt-nut assembly is illustrated in U.S. Pat. No. 4,627,774 for LIMITING TORQUE BOLT-NUT ASSEMBLY issued Dec. 9, 1986 to Earl T. Bradley, and assigned to EBAA Iron Inc. of Eastland, Tex., USA. In this example, the protective nut (7) illustrated in this patent (FIG. 1, callout 7, of U.S. Pat. No. 4,627,774) is replaced by the present invention with a corresponding significant reduction in overall product cost and increase in product functionality.

Thus, one embodiment of the present invention anticipates the incorporation of the torque shearing nut described herein with a limiting torque bolt-nut assembly used in conjunction within the context of a pipe joint restrainer gland system. The resulting system has lower weight, lower manufacturing cost, increased ease of production, and permits recycling of materials in a way not possible with the prior art. Additionally, the elimination of forging in the manufacturing process drastically decreases the amount of electrical energy required to produce the resulting restraining gland system.

### Method Overview (1600)

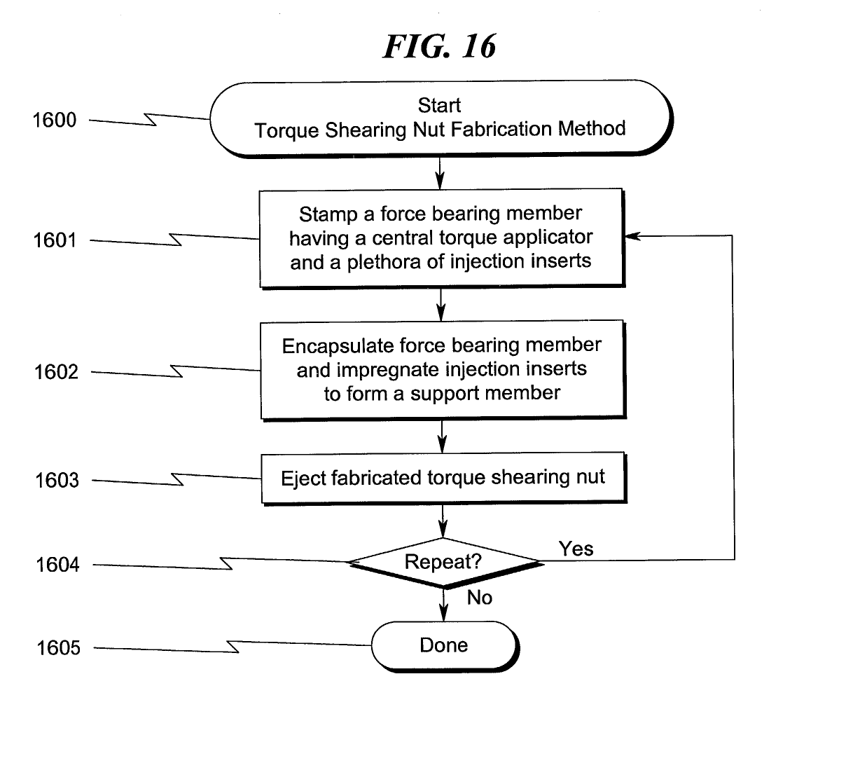

The general method taught by the present invention deals specifically with a manufacturing method associated with making twistnuts from hybrid materials in order to reduce overall product costs for this device. This starts by replacing the conventional twistnut hot-forging process with an injection molding process (1600) in which a metal washer or other hard insert is used to replace the torque-bearing elements of the twistnut as implemented in the prior art. The general methodology of fabrication is illustrated by the flowchart in FIG. 16 (1600) and has been described previously.

Significant to this method is the use of metal stamping or some other inexpensive process to form the torque-bearing member of the twistnut. This is followed by the use of injection molding with any variety of hard plastics (polyamides (nylon), polypropylene (PP), etc.) that can withstand the harsh environment of transport as well as resiliently hold the form of a hexagonal nut or other form while being torqued as illustrated in FIG. 1 (0102) within a field application. While a wide variety of plastics is suitable for this application, a variety of polyamide and polypropylene based products may prove particularly useful in many applications.

### CONCLUSION

A torque shearing nut system and method incorporating a hybrid “twistnut” constructed of a metallic force bearing member and a thermoplastic rubber (Vyram®, etc.) and/or plastic (polyamide (nylon), polypropylene (PP), etc.) surrounding support member has been disclosed. The present invention permits the use of one or more steel washer inserts formed to permit shearing of an external axial element for the purposes of ensuring the application of a predefined torque to the external axial member.

The primary advantage of the present invention is one of cost, in that the present invention can be manufactured using stamped steel washers that are surrounded with and impregnated with molded thermoplastic rubber (Vyram®, etc.) and/or plastic (polyamide (nylon), polypropylene (PP), etc.). This encapsulation process is significantly less expensive than traditional hot-forging methodologies used to manufacture prior art twistnuts.

Furthermore, the present invention permits a reduction in the complexity of manufacturing steps required to both manufacture the twistnuts as well as combine them with the external axial member. Note that an additional feature of the present invention is that it may be manufactured without the need for specialized hot forge tooling and hot forge machinery, and as such the production volume limitations of the prior art are not present in the manufacture of the present invention.

Finally, the present invention permits new formulations of limiting torque bolt-nut assemblies to be incorporated within pipe joint restrainer glands and pipe junction holders. These new formulations are highly cost reduced, lower in weight, recyclable, and require substantially reduced amounts of energy to both manufacture and transport as compared to prior art solutions.

Although a preferred embodiment of the present invention has been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims:

What is claimed is:

1. A torque shearing nut system comprising:
(a) a force bearing member means having a central torque application means and a plethora of injection inserts;
(b) a support member means encapsulating said force bearing member and impregnating said injection inserts;
wherein
said torque application means permits rotation of an external axial member via said torque application means and shearing of said member at a predefined torque value;
said support member means has an external perimeter with a plethora of paired parallel surfaces that permit application of torque to said support member; and
said impregnation of said injection inserts by said support member means permits transfer of torque from said paired parallel surfaces to said central torque application means.

2. The torque shearing nut system of claim 1 wherein said nut is used within the context of a limiting torque bolt-nut assembly.

3. The torque shearing nut system of claim 1 wherein said support member means is comprised of thermoplastic rubber.

4. The torque shearing nut system of claim 3 wherein said thermoplastic rubber is Vyram® brand thermoplastic rubber.

5. The torque shearing nut system of claim 3 wherein said thermoplastic rubber is Vyram® 9103-45 brand thermoplastic rubber.

6. The torque shearing nut system of claim 1 wherein said support member means is comprised of plastic.

7. The torque shearing nut system of claim 6 wherein said plastic is a polyamide.

8. The torque shearing nut system of claim 6 wherein said plastic is a polypropylene.

9. The torque shearing nut system of claim 6 wherein said plastic is high-density polyethylene (HDPE).

10. The torque shearing nut system of claim 7 wherein said external axial member is retained within said support member means via a fastener.

11. The torque shearing nut system of claim 7 wherein said support member means is press-fit to said external axial member.

12. The torque shearing nut system of claim 1 wherein said injection inserts are semi-circular.

13. The torque shearing nut system of claim 1 wherein said injection inserts are rectangular.

14. The torque shearing nut system of claim 1 wherein said force bearing member is a washer.

15. The torque shearing nut system of claim 1 wherein said force bearing member is a tonsil washer.

16. The torque shearing nut system of claim 1 wherein said force bearing member comprises multiple washers.

17. The torque shearing nut system of claim 15 wherein said washer is comprised of a mild steel.

18. The torque shearing nut system of claim 15 wherein said washer is comprised of a high strength/low alloy steel.

19. The torque shearing nut system of claim 15 wherein said washer is comprised of heat treated carbon steel.

20. The torque shearing nut system of claim 15 wherein said washer is comprised of ultra-high strength steel (UHSS).

21. The torque shearing nut system of claim 15 wherein said washer is comprised of MartINsite® steel.

22. The torque shearing nut system of claim 15 wherein said washer is hexagonal.

23. The torque shearing nut system of claim 15 wherein said washer is square.

24. The torque shearing nut system of claim 15 wherein said washer has a central torque application means comprising two parallel surfaces connected via two circular arcs.

25. The torque shearing nut system of claim 15 wherein said washer has one or more perpendicular tabs to permit transfer of torque from said paired parallel surfaces to said central torque application means.

26. A pipe joint restrainer gland assembly incorporating a torque shearing nut system comprising:
(a) a force bearing member means having a central torque application means and a plethora of injection inserts;
(b) a support member means encapsulating said force bearing member and impregnating said injection inserts;
wherein
said torque application means permits rotation of an external axial member via said torque application means and shearing of said member at a predefined torque value;
said support member means has an external perimeter with a plethora of paired parallel surfaces that permit application of torque to said support member;
said impregnation of said injection inserts by said support member means permits transfer of torque from said paired parallel surfaces to said central torque application means;
said force bearing member means and said support member means are integrated and form a protective drive nut in a limiting torque bolt-nut assembly; and
said limiting torque bolt-nut assembly is incorporated as a retaining means in a pipe joint restrainer gland.

27. The pipe joint restrainer gland assembly incorporating a torque shearing nut system of claim 26 wherein said nut is used within the context of a limiting torque bolt-nut assembly.

28. The pipe joint restrainer gland assembly incorporating a torque shearing nut system of claim 26 wherein said support member means is comprised of thermoplastic rubber.

29. The pipe joint restrainer gland assembly incorporating a torque shearing nut system of claim 28 wherein said thermoplastic rubber is Vyram® brand thermoplastic rubber.

30. The pipe joint restrainer gland assembly incorporating a torque shearing nut system of claim 28 wherein said thermoplastic rubber is Vyram® 9103-45 brand thermoplastic rubber.

31. The pipe joint restrainer gland assembly incorporating a torque shearing nut system of claim 26 wherein said support member means is comprised of plastic.

32. The pipe joint restrainer gland assembly incorporating a torque shearing nut system of claim 31 wherein said plastic is a polyamide.

33. The pipe joint restrainer gland assembly incorporating a torque shearing nut system of claim 31 wherein said plastic is a polypropylene.

34. The pipe joint restrainer gland assembly incorporating a torque shearing nut system of claim 31 wherein said plastic is high-density polyethylene (HDPE).

35. The pipe joint restrainer gland assembly incorporating a torque shearing nut system of claim 32 wherein said external axial member is retained within said support member means via a fastener.

36. The pipe joint restrainer gland assembly incorporating a torque shearing nut system of claim 32 wherein said support member means is press-fit to said external axial member.

37. The pipe joint restrainer gland assembly incorporating a torque shearing nut system of claim 26 wherein said injection inserts are semi-circular.

38. The pipe joint restrainer gland assembly incorporating a torque shearing nut system of claim 26 wherein said injection inserts are rectangular.

39. The pipe joint restrainer gland assembly incorporating a torque shearing nut system of claim 26 wherein said force bearing member is a washer.

40. The pipe joint restrainer gland assembly incorporating a torque shearing nut system of claim 26 wherein said force bearing member is a tonsil washer.

41. The pipe joint restrainer gland assembly incorporating a torque shearing nut system of claim 26 wherein said force bearing member comprises multiple washers.

42. The pipe joint restrainer gland assembly incorporating a torque shearing nut system of claim 40 wherein said washer is comprised of a mild steel.

43. The pipe joint restrainer gland assembly incorporating a torque shearing nut system of claim 40 wherein said washer is comprised of a high strength/low alloy steel.

44. The pipe joint restrainer gland assembly incorporating a torque shearing nut system of claim 40 wherein said washer is comprised of heat treated carbon steel.

45. The pipe joint restrainer gland assembly incorporating a torque shearing nut system of claim 40 wherein said washer is comprised of ultra-high strength steel (UHSS).

46. The pipe joint restrainer gland assembly incorporating a torque shearing nut system of claim 40 wherein said washer is comprised of MartINsite® steel.

47. The pipe joint restrainer gland assembly incorporating a torque shearing nut system of claim 40 wherein said washer is hexagonal.

48. The pipe joint restrainer gland assembly incorporating a torque shearing nut system of claim 40 wherein said washer is square.

49. The pipe joint restrainer gland assembly incorporating a torque shearing nut system of claim 40 wherein said washer has a central torque application means comprising two parallel surfaces connected via two circular arcs.

50. The pipe joint restrainer gland assembly incorporating a torque shearing nut system of claim 40 wherein said washer has one or more perpendicular tabs to permit transfer of torque from said paired parallel surfaces to said central torque application means.

51. A torque shearing nut fabrication method comprising:
(1) stamping a force bearing member means having a central torque application means and a plethora of injection inserts; and
(2) encapsulating said force bearing member and impregnating said injection inserts to form a support member means;
wherein
said encapsulating step mechanically links said force bearing member to said support member.

52. The torque shearing nut fabrication method of claim 51 wherein said nut is press-fit on a shaft member to form a limiting torque bolt-nut assembly.

53. The torque shearing nut fabrication method of claim 51 wherein said support member means is comprised of thermoplastic rubber.

54. The torque shearing nut fabrication method of claim 53 wherein said thermoplastic rubber is Vyram® brand thermoplastic rubber.

55. The torque shearing nut fabrication method of claim 53 wherein said thermoplastic rubber is Vyram® 9103-45 brand thermoplastic rubber.

56. The torque shearing nut fabrication method of claim 51 wherein said support member means is comprised of plastic.

57. The torque shearing nut fabrication method of claim 56 wherein said plastic is a polyamide.

58. The torque shearing nut fabrication method of claim 56 wherein said plastic is a polypropylene.

59. The torque shearing nut fabrication method of claim 56 wherein said plastic is high-density polyethylene (HDPE).

60. The torque shearing nut fabrication method of claim 57 wherein said external axial member is retained within said support member means via a fastener.

61. The torque shearing nut fabrication method of claim 57 wherein said support member means is press-fit to said external axial member.

62. The torque shearing nut fabrication method of claim 51 wherein said injection inserts are semi-circular.

63. The torque shearing nut fabrication method of claim 51 wherein said injection inserts are rectangular.

64. The torque shearing nut fabrication method of claim 51 wherein said force bearing member is a washer.

65. The torque shearing nut fabrication method of claim 51 wherein said force bearing member is a tonsil washer.

66. The torque shearing nut fabrication method of claim 51 wherein said force bearing member comprises multiple washers.

67. The torque shearing nut fabrication method of claim 65 wherein said washer is comprised of a mild steel.

68. The torque shearing nut fabrication method of claim 65 wherein said washer is comprised of a high strength/low alloy (HSLA) steel.

69. The torque shearing nut fabrication method of claim 65 wherein said washer is comprised of heat treated carbon steel.

70. The torque shearing nut fabrication method of claim 65 wherein said washer is comprised of ultra-high strength steel (UHSS).

71. The torque shearing nut fabrication method of claim 65 wherein said washer is comprised of MartINsite® steel.

72. The torque shearing nut fabrication method of claim 65 wherein said washer is hexagonal.

73. The torque shearing nut fabrication method of claim 65 wherein said washer is square.

74. The torque shearing nut fabrication method of claim 65 wherein said washer has a central torque application means comprising two parallel surfaces connected via two circular arcs.

75. The torque shearing nut fabrication method of claim 65 wherein said washer has one or more perpendicular tabs to permit transfer of torque from said paired parallel surfaces to said central torque application means.
